(19) United States
(12) Patent Application Publication
(10) Pub. No.: US 2025/0128908 A1
(43) Pub. Date: Apr. 24, 2025

(54) FLEXIBLE TUBING GUIDANCE DEVICE

(71) Applicant: LEHNEN INDUSTRIAL SERVICES, INC., Keene, NH (US)

(72) Inventor: Peter Lehnen, Keene, NH (US)

(21) Appl. No.: 18/687,906

(22) PCT Filed: Aug. 29, 2022
(86) PCT No.: PCT/US22/41829

§ 371 Date: Feb. 29, 2024

Related U.S. Application Data
(60) Provisional application No. 63/238,458, filed on Aug. 30, 2021.

(51) Int. Cl. B65H 57/14

(52) U.S. Cl. CPC B65H 57/14; B65H 2403/51; B65H 2701/33

(57) ABSTRACT

A flexible tubing guidance device is disclosed. In accordance with some embodiments, the disclosed device may include a plurality of internal roller elements to facilitate passing of tubing through the bore of a block body. In accordance with some embodiments, the disclosed device also may include a clamping mechanism to provide a clamping force for holding the tubing in place. The clamping mechanism may be mounted on an exterior of the block body and may employ a drive element that provides a camming action for several jaw elements that contact the exterior of the tubing. In accordance with some embodiments, the disclosed device may be utilized, for example, for accurately aligning and/or measuring of flexible tubing for cutting thereof. In accordance with some embodiments, the disclosed device may be configured to minimize (or otherwise reduce) the likelihood of bunching or jamming of the flexible tubing during processing thereof.

### CROSS-REFERENCE TO RELATED APPLICATIONS

This patent application claims the benefit of and priority to U.S. Provisional Patent Application No. 63/238,458, titled “Flexible Tubing Guidance Device,” filed on Aug. 30, 2021, which is herein incorporated by reference in its entirety.

### FIELD OF THE DISCLOSURE

The present disclosure relates to flexible tubing and, more particularly, to guidance of flexible tubing for alignment, measurement, and cutting thereof.

### BACKGROUND

Flexible tubing is often used for transporting and collecting liquids and gases in the medical, automotive, chemical, and other industries. Example flexible tubing materials may include polyvinyl chloride (PVC), polytetrafluoroethylene (PTFE), fluorinated ethylene propylene (FEP), perfluoroalkoxy alkane (PFA), polychlorotrifluoroethylene (PCTFE), ethylene propylene diene monomer (EPDM) rubber, latex rubber, silicone rubber, nitrile rubber, polyurethane, and polychloroprene, to name a few.

### SUMMARY

The subject matter of this application may involve, in some cases, interrelated products, alternative solutions to a particular problem, and/or a plurality of different uses of a single system or article.

One example embodiment provides a flexible tubing guidance device. The device includes a body portion having a bore formed therein. The device further includes a plurality of roller elements disposed within the body portion and at least partially extending into the bore to contact flexible tubing passing through the bore.

In some cases, the plurality of roller elements is configured to roll in a direction substantially in-line with a longitudinal axis of the bore. In some cases, the plurality of roller elements is provided in a substantially linear arrangement that extends along a longitudinal axis of the bore. In some cases, at least one of the plurality of roller elements is configured to contact the flexible tubing directly. In some cases, at least one of the plurality of roller elements is configured to contact the flexible tubing indirectly through at least one intervening layer. In some cases, the plurality of roller elements includes at least one ball bearing on an axle. In some cases, at least one of the plurality of roller elements has a coating layer disposed thereon such that the coating layer contacts the flexible tubing directly. In some cases, the plurality of roller elements includes at least two roller elements offset from one another around the bore at an angle in the range of about 45°-180°. In some such instances, the angle is about 45°. In some other such instances, the angle is about 90°. In some other such instances, the angle is about 120°. In some other such instances, the angle is about 180°.

In some cases, the bore extends from a first end face of the body portion to a second end face of the body portion. In some cases, the bore is substantially linear. In some cases, at least a portion of the bore is of closed-curve cross-sectional geometry. In some such instances, the closed-curve cross-sectional geometry is substantially circular.

In some cases, the device further includes a clamping mechanism configured to apply a clamping force to an exterior of the flexible tubing exiting the bore. In some cases, the clamping mechanism is disposed at an end of the body portion. In some cases, the clamping mechanism is disposed outside of the body portion.

In some cases, the clamping mechanism includes: a plurality of jaw elements; and a drive element configured to drive the plurality of jaw elements radially inward toward one another in applying the clamping force to the exterior of the flexible tubing. In some cases, the plurality of jaw elements includes at least one jaw element that is of substantially wedge-shaped prism geometry. In some cases, the plurality of jaw elements includes four jaw elements of substantially wedge-shaped prism geometry and arranged adjacent one another in a common plane such that inner vertices of the four jaw elements generally point toward one another. In some such instances, the inner vertices substantially surround a longitudinal axis of the bore. In some cases, the plurality of jaw elements includes at least one jaw element having a rounded inner vertex configured to contact the exterior of the flexible tubing. In some cases, the drive element is of substantially annular geometry. In some cases, the drive element includes a tab portion configured to have a force applied thereto to effectuate rotation of the drive element. In some cases, in being configured to drive the plurality of jaw elements radially inward toward one another, the drive element is configured with a camming action. In some cases: the drive element has at least one slot formed therein; and at least one biasing element is disposed within the at least one slot. In some such instances, the at least one biasing element includes a spring.

In some cases, the body portion includes a collar portion extending from an end face thereof. In some such instances, the clamping mechanism is mounted within the collar portion. In some cases, the body portion includes a groove formed adjacent the collar portion. In some such instances, the drive element is disposed within the groove.

Another example embodiment provides a flexible tubing guidance device. The device includes a body portion having a bore formed therein, the bore extending from a first end face of the body portion to a second end face of the body portion. The device also includes a plurality of roller elements disposed within the body portion and at least partially extending into the bore to contact flexible tubing passing through the bore. The device further includes a clamping mechanism disposed at the second end face of the body portion and configured to apply a clamping force to an exterior of the flexible tubing exiting the bore, the clamping mechanism including: a plurality of jaw elements; and a drive element configured to drive the plurality of jaw elements radially inward toward one another in applying the clamping force to the exterior of the flexible tubing.

In some cases: the body portion includes a collar portion extending from the second end face thereof; and the clamping mechanism is mounted within the collar portion. In some such instances, the plurality of jaw elements is connected to the collar portion by at least one of a pin and a fastening element.

In some cases, the plurality of jaw elements includes at least one jaw element that is of substantially wedge-shaped prism geometry. In some cases, the plurality of jaw elements includes at least four jaw elements arranged adjacent one another in plane. In some cases, the plurality of jaw elements includes at least one jaw element having a rounded inner vertex configured to contact the exterior of the flexible tubing.

In some cases: the body portion includes a collar portion extending from the second end face thereof and a groove formed adjacent the collar portion; and the drive element is disposed within the groove.

In some cases, the drive element is of annular geometry. In some cases, the drive element includes a tab portion configured to effectuate rotation of the drive element. In some cases: the drive element has at least one slot formed therein; and at least one biasing element is disposed within the at least one slot. In some cases, in being configured to drive the plurality of jaw elements radially inward toward one another, the drive element is configured with a camming action.

In some cases, the bore is of substantially circular cross-sectional geometry. In some cases, the bore extends through the body portion in a substantially linear manner.

In some cases, the plurality of roller elements includes at least one ball bearing on an axle. In some cases, the plurality of roller elements includes at least two roller elements offset from one another at an angle of about 90°. In some cases, the plurality of roller elements includes at least two roller elements offset from one another at an angle of about 180°. In some cases, the plurality of roller elements is in a linear arrangement that extends along the bore. In some cases, the plurality of roller elements includes at least one roller element having a coating layer disposed thereon such that the coating layer contacts the exterior of the flexible tubing passing through the bore.

In some cases, the body portion is of substantially rectangular prism geometry. In some cases, at least one of the first end face and the second end face is substantially planar and is of substantially rectangular or square geometry.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIGS. 1-2 illustrate several views of a flexible tubing guidance device configured in accordance with an embodiment of the present disclosure.

FIG. 3 illustrates a view of a body portion configured in accordance with an embodiment of the present disclosure.

FIG. 4 illustrates a view of a plurality of roller elements configured in accordance with an embodiment of the present disclosure.

FIGS. 5-7 illustrate several views of a plurality of roller elements disposed within a body portion, in accordance with an embodiment of the present disclosure.

FIG. 8 illustrates a view of a clamping mechanism configured in accordance with an embodiment of the present disclosure.

FIGS. 9-10 illustrate several views of a jaw element configured in accordance with an embodiment of the present disclosure.

FIGS. 11-13 illustrate several views of the installation of a clamping mechanism within collar portion, in accordance with an embodiment of the present disclosure.

FIG. 14 illustrates a view of clamping mechanism in a first state (e.g., an open or undeflected state) in accordance with an embodiment of the present disclosure.

FIG. 15 illustrates a view of clamping mechanism in a second state (e.g., a closed or deflected state) in accordance with an embodiment of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

A flexible tubing guidance device is disclosed. In accordance with some embodiments, the disclosed device may include a plurality of internal roller elements to facilitate passing of tubing through the bore of a block body. In accordance with some embodiments, the disclosed device also may include a clamping mechanism to provide a clamping force for holding the tubing in place. The clamping mechanism may be mounted on an exterior of the block body and may employ a drive element that provides a camming action for several jaw elements that contact the exterior of the tubing. In accordance with some embodiments, the disclosed device may be utilized, for example, for accurately aligning and/or measuring of flexible tubing for cutting thereof. In accordance with some embodiments, the disclosed device may be configured to minimize (or otherwise reduce) the likelihood of bunching or jamming of the flexible tubing during processing thereof. Numerous configurations and variations will be apparent in light of this disclosure.

### General Overview

Flexible tubing, especially softer kinds made from silicone and the like, is not amenable to being pushed through a closefitting aperture. As soon as there is any resistance, the tubing bulges, and processing typically must be stopped to clear the jam and reset.

One existing approach to cutting flexible tubing involves pinching the tubing between adjustable wheels or belts to move it and then guiding it through a round bushing to support it during the cutting process. However, if the flexible tubing has a high coefficient of friction and is being pushed (rather than pulled), it typically resists sliding through the bushing, tending to misalign ahead of entering the bushing. One approach to overcoming this difficulty involves slathering the tubing in alcohol to lubricate it as it passes through the bushing. This approach, however, requires non-trivial efforts in management and disposal of the liquid, as well as introduces health and safety issues stemming from the vapors produced by the alcohol.

Another existing approach to cutting tubing involves a spinning knife assembly that gradually cuts through the tubing wall. However, this approach results in significant slivering of the tubing, the sliced-off pieces creating particulate contamination. One approach to overcoming this difficulty involves utilizing a knife blade as a guillotine. However, this approach limits the range of tubing sizes that can be cut with a single machine.

Thus, and in accordance with some embodiments of the present disclosure, a flexible tubing guidance device is disclosed. In accordance with some embodiments, the disclosed device may include a plurality of internal roller elements to facilitate passing of tubing through the bore of a block body. In accordance with some embodiments, the disclosed device also may include a clamping mechanism to provide a clamping force for holding the tubing in place. The clamping mechanism may be mounted on an exterior of the block body and may employ a drive element that provides a camming action for several jaw elements that contact the exterior of the tubing. In accordance with some embodiments, the disclosed device may be utilized, for example, for accurately aligning and/or measuring of flexible tubing for cutting thereof. In accordance with some embodiments, the disclosed device may be configured to minimize (or otherwise reduce) the likelihood of bunching or jamming of the flexible tubing during processing thereof.

In accordance with some embodiments, the disclosed device may be configured, at least in some instances, to have sufficient anti-friction characteristics so that any type of flexible tubing, with any given level of surface stickiness or tackiness, may be pushed through the device with no (or otherwise minimal) lubrication. Thus, in a general sense, the disclosed device may be utilized, for example, for processing flexible tubing while eliminating the need for lubrication of the tubing, in accordance with some embodiments.

### Structure and Operation

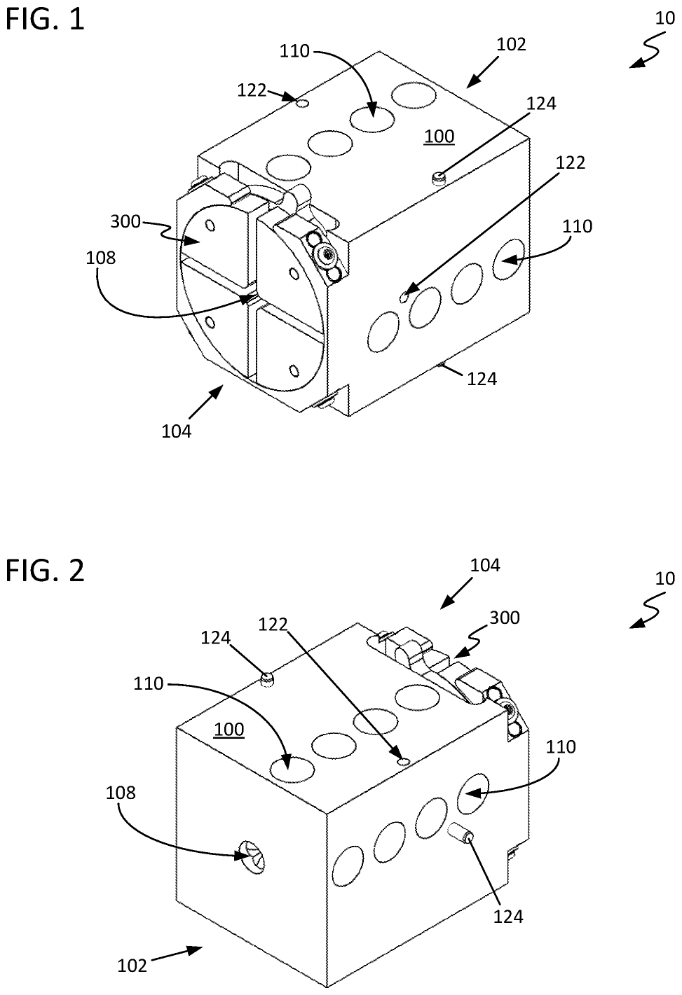

FIGS. 1-2 illustrate several views of a flexible tubing guidance device 10 configured in accordance with an embodiment of the present disclosure. As can be seen, device 10 may include: (1) a body portion 100; (2) one or more roller elements 200; and (3) a clamping mechanism 300. Each of these elements is discussed in turn below. Device 10 may be configured, in accordance with some embodiments, to facilitate reliable alignment and/or length measurement for cutting of flexible tubing passed therethrough. To that end, such tubing may be passed through body portion 100 along roller element(s) 200 and clamped by clamping mechanism 300, in accordance with some embodiments.

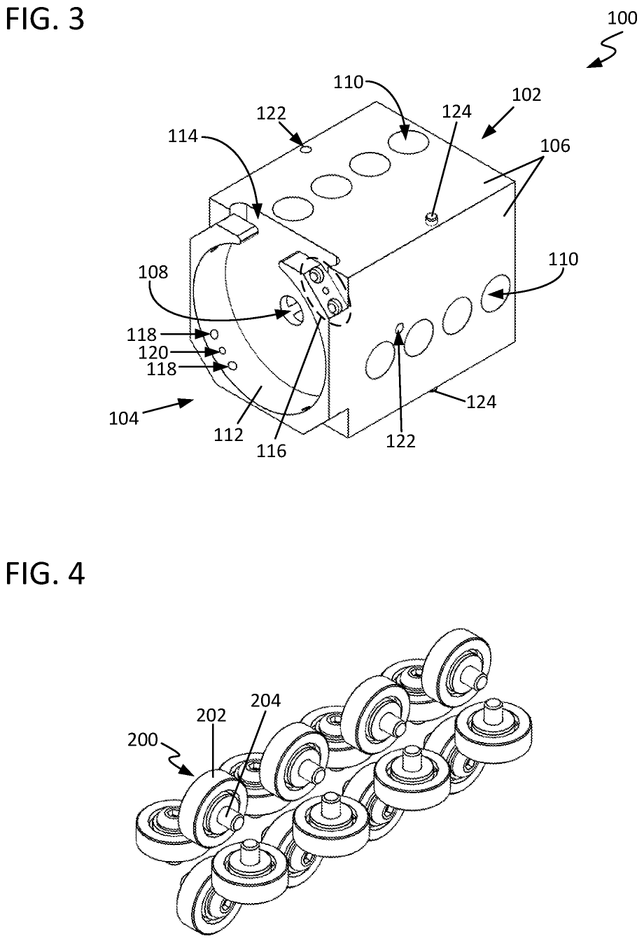

As previously noted, device 10 may include a body portion 100. FIG. 3 illustrates a view of a body portion 100 configured in accordance with an embodiment of the present disclosure. As can be seen, body portion 100 may have a first end face 102, a second end face 104 situated opposite first end face 102, a plurality of side faces 106, a bore 108, and a collar portion 112, in accordance with some embodiments. Each of these elements is discussed in turn below.

The material composition of body portion 100 may be customized, as desired for a given target application or end-use. In some embodiments, body portion 100 may be comprised, in part or in whole, of a metal or alloy. For instance, in some cases, body portion 100 may be comprised of aluminum (Al) or a steel (e.g., stainless steel). Body portion 100 may be of monolithic (e.g., single-piece) or polylithic (e.g., multi-piece) construction, as desired.

The geometry and dimensions of body portion 100 may be customized, as desired for a given target application or end-use. As can be seen from FIGS. 1-3, for example, in some embodiments, body portion 100 may have a generally polyhedral shape, such as that of a square prism or rectangular prism. In such cases, body portion 100 may have a generally square or rectangular cross-sectional geometry, though other polygonal geometries may be provided, as desired. It should be noted, however, that the present disclosure is not intended to be so limited, as in some other embodiments, body portion 100 may have a generally cylindrical shape, such as that of a circular cylinder or elliptical cylinder. In such cases, body portion 100 may have a generally circular or elliptical cross-sectional geometry, though other closed-curve geometries may be provided, as desired. Also, as will be appreciated, in such cases, body portion 100 may have a single curved side face 106 rather than multiple individual side faces 106.

The geometry and dimensions of each end face 102, 104 also may be customized, as desired for a given target application or end-use. As will be appreciated in light of this disclosure, the geometry of a given end face 102, 104 generally may depend on the overall geometry of body portion 100. As can be seen from FIGS. 1-3, for example, either (or both) end faces 102, 104 may be rectangular or square in geometry, in accordance with some embodiments. As will be appreciated in light of this disclosure, other polygonal and closed-curve geometries may be provided instead, in accordance with other embodiments. As can be seen further from FIGS. 1-3, either (or both) end faces 102, 104 may be substantially planar in profile, in accordance with some embodiments. As will be appreciated in light of this disclosure, a non-planar profile may be provided instead, in accordance with other embodiments. In some cases, first end face 102 and second end face 104 may be of substantially the same geometry and/or planarity, whereas in some other cases, end faces 102, 104 may differ in geometry and/or planarity in one or more ways. Moreover, in some cases, first end face 102 and second end face 104 may be of substantially the same dimensions, whereas in some other cases, end faces 102, 104 may differ in one or more dimensions (e.g., one of end faces 102, 104 may be a smaller or larger version of the other of end faces 102, 104).

The geometry and dimensions of each side face 106 may be customized, as desired for a given target application or end-use. As will be appreciated in light of this disclosure, the geometry of a given side face 106 generally may depend on the overall geometry of body portion 100. Moreover, the quantity of side faces 106 also may depend on the overall geometry of body portion 100. As can be seen from FIGS. 1-3, for example, body portion 100 may have four side faces 106, in accordance with some embodiments. As will be appreciated in light of this disclosure, lesser and greater quantities of side faces 106 may be provided instead, in accordance with other embodiments. For instance, body portion 100 may have 3, 5, 6, or more side faces 106. As can be seen further from FIGS. 1-3, all (or some sub-set) of side faces 106 may be substantially planar in profile, in accordance with some embodiments. As will be appreciated in light of this disclosure, a non-planar profile may be provided instead, in accordance with other embodiments. In some cases, all (or some sub-set) of side faces 106 may be of substantially the same geometry and/or planarity, whereas in some other cases, at least two side faces 106 may differ in geometry and/or planarity in one or more ways. Moreover, in some cases, all (or some sub-set) of side faces 106 may be of substantially the same dimensions, whereas in some other cases, at least two side faces 106 may differ in one or more dimensions (e.g., one side face 106 may be a smaller or larger version of another side faces 106).

As can be seen further from FIGS. 1-3, bore 108 may extend through body portion 100 from first end face 102 to second end face 104, providing an uninterrupted passageway through the length of body portion 100. In some cases, bore 108 may extend through body portion 100 in a substantially linear manner, whereas in some other cases, bore 108 may extend therethrough in a non-linear manner (e.g., curved, undulating, articulating, etc.).

The geometry and dimensions of bore 108 may be customized, as desired for a given target application or end-use. As can be seen from FIGS. 1-3, for example, at least a portion of bore 108 may be generally circular in cross-section, in accordance with an embodiment. As will be appreciated in light of this disclosure, other closed-curve or polygonal cross-sectional geometries may be provided for a given portion of bore 108 instead, in accordance with other embodiments. As will be appreciated in light of this disclosure, it may be desirable to ensure that the geometry and dimensions of bore 108 are suitable for the geometry and dimensions of flexible tubing to be passed through device 10. For instance, bore 108 may be configured to accommodate tubing having a diameter of about ¼ inch, ½ inch, ¾ inch, 1 inch, 1¼ inches, 1½ inches, 1¾ inches, 2 inches, or any other desired diameter/width. In some cases, bore 108 may be of substantially the same geometry at both first end face 102 and second end face 104, whereas in some other cases, bore 108 may differ in geometry at first end face 102 as compared to second end face 104 in one or more ways. Moreover, in some cases, bore 108 may be of substantially the same dimensions at both first end face 102 and second end face 104, whereas in some other cases, bore 108 may differ in one or more dimensions at first end face 102 as compared to second end face 104.

In some embodiments, a given side face 106 may have one or more openings 110 formed therein. A given opening 110 may extend from a given side face 106 into the interior of body portion 100, opening into an internal area adjacent to bore 108. A given opening 110 may be configured to host a given roller element 200 (discussed below). To that end, a given opening 110 may be configured to permit ready access to mounting hardware (e.g., an axle 204) associated with a given roller element 200 within the interior of body portion 100.

The geometry and dimensions of a given opening 110 may be customized, as desired for a given target application or end-use. As can be seen from FIGS. 1-3, for example, a given opening 110 may be generally circular in cross-section, in accordance with an embodiment. As will be appreciated in light of this disclosure, other closed-curve and polygonal cross-sectional geometries may be provided instead, in accordance with other embodiments. In some instances, all (or some sub-set) of openings 110 may be configured similarly, whereas in some other instances, at least one opening 110 may differ in configuration from at least one other opening 110.

The quantity and arrangement of openings 110 for a given side face 106 may be customized, as desired for a given target application or end-use. As can be seen from FIGS. 1-3, for example, a given side face 106 may include a plurality of openings 110 in a substantially linear arrangement, in accordance with some embodiments. As will be appreciated in light of this disclosure, non-linear arrangements of openings 110 may be provided instead, in accordance with other embodiments. In some instances, a given side face 106 may include only a single opening 110 for accommodating a single roller element 200.

As can be seen further, second end face 104 of body portion 100 may have a collar portion 112. Collar portion 112 may be configured, in accordance with some embodiments, to host clamping mechanism 300 (discussed below). The geometry and dimensions of collar portion 112 may be customized, as desired for a given target application or end-use. As can be seen from FIGS. 1-3, for example, collar portion 112 may be of generally annular (e.g., ring-shaped) geometry, in accordance with some embodiments. Some example such geometries may include circular, elliptical, square, rectangular, pentagonal, hexagonal, heptagonal, octagonal, etc., ring-shaped geometries. As will be appreciated in light of this disclosure, other geometries may be provided, in accordance with other embodiments.

In accordance with some embodiments, body portion 100 may include a groove 114 formed adjacent collar portion 112. Groove 114 may be configured, in accordance with some embodiments, to host tab portion 332 of drive element 330 (discussed below). The geometry and dimensions of groove 114 may be customized, as desired for a given target application or end-use.

In accordance with some embodiments, the exterior of collar portion 112 may have one or more mounting regions 116. A given mounting region 116 may be configured, in accordance with some embodiments, to assist with mounting of a given jaw element 310 (of clamping mechanism 300, discussed below) within collar portion 112. To that end, a given mounting region 116 may be, for example, a chamfered edge having formed therein: (1) one or more openings 118; and (2) one or more openings 120. A given opening 118 may be configured, in accordance with some embodiments, to slidably receive and retain a pin 320 in retention of jaw elements 310 within collar portion 112. A given opening 120 may be configured, in accordance with some embodiments, to receive and retain a fastening element 322 (e.g., a screw or bolt) in retention of jaw elements 310 within collar portion 112. In at least some cases, a fastening element 322 disposed in opening 120 may serve to retain pin(s) 320 disposed within opening(s) 118 (e.g., such as through a physically overlapped arrangement).

In accordance with some embodiments, a given side face 106 of device 10 may have formed therein one or more recesses 122 configured to receive and retain a pin 124 (or other fastening element) of another device 10. Such recess 122 and pin 124 interfacing may be utilized in connecting multiple devices 10 together, providing the overall system with a given degree of modularity. The quantity and arrangement of recesses 122 and pins 124 may be customized, as desired for a given target application or end-use.

As previously noted, device 10 also may include one or more roller elements 200. FIG. 4 illustrates a view of a plurality of roller elements 200 configured in accordance with an embodiment of the present disclosure. A given roller element 200 may be disposed within body portion 100 and generally configured, in accordance with some embodiments, to contact (e.g., directly or indirectly) the exterior of a given type of tubing and to facilitate the passing of that tubing through bore 108 while minimizing (or otherwise reducing) the likelihood of bunching or jamming, whether friction related or otherwise. To that end, a given roller element 200 may be (or otherwise may include) a ball bearing 202 on an axle 204, in accordance with some embodiments. In at least some cases, axle 204 may be a fastener, such as a screw, pin, or other suitable fastening element. Other suitable types of roller elements 200 may be provided, in accordance with some other embodiments.

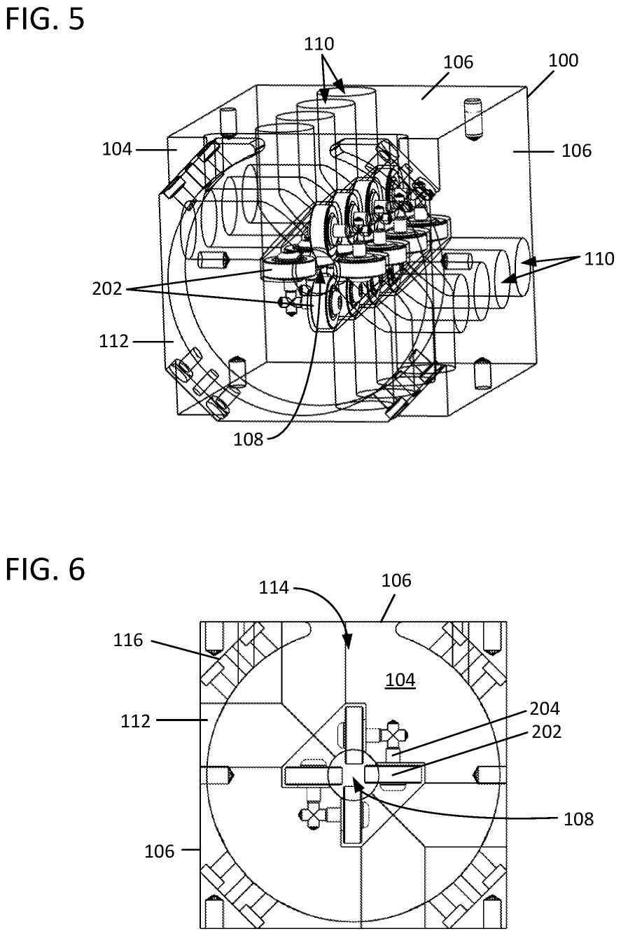

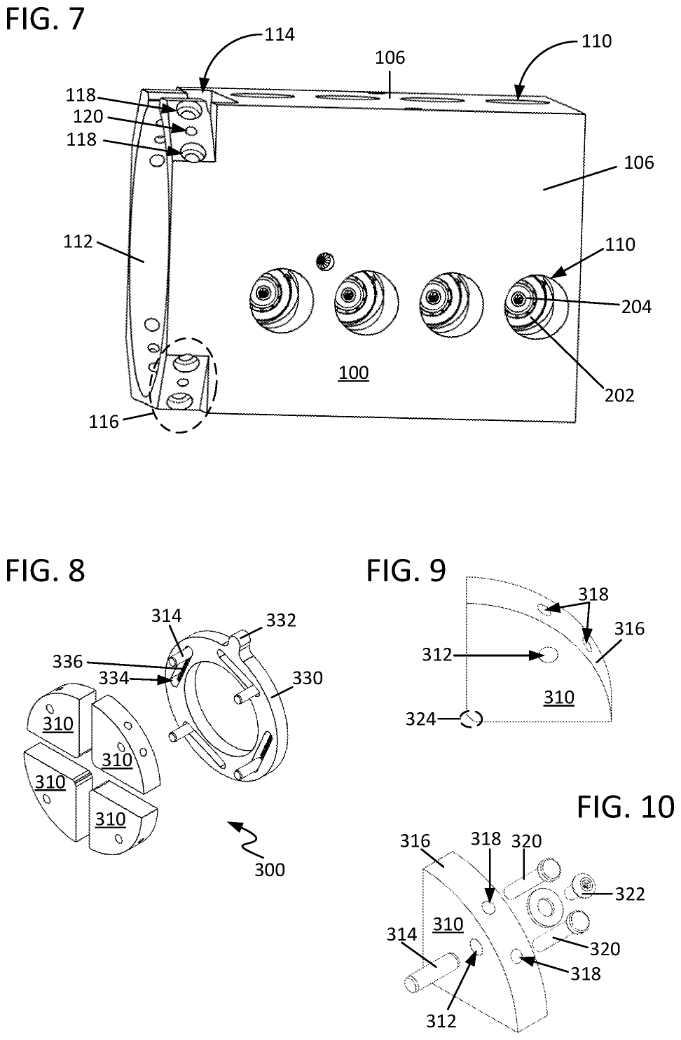

FIGS. 5-7 illustrate several views of a plurality of roller elements 200 disposed within body portion 100, in accordance with an embodiment of the present disclosure. As can be seen, a given roller element 200 may be situated so as to at least partially extend into bore 108 to make contact with the exterior of tubing as it passes through bore 108. In some cases, the external contact surface of a given roller element 200 may directly contact the exterior of tubing, whereas in other cases, indirect contact (e.g., via one or more intervening layers) may be provided. In a general sense, all (or some sub-set) of roller elements 200 may be configured, in accordance with some embodiments, to the passing of tubing through device 10 while minimizing (or otherwise reducing) the likelihood of bunching or jamming, whether friction related or otherwise.

The quantity and arrangement of roller elements 200 may be customized, as desired for a given target application or end-use. As can be seen from FIGS. 4-6, for example, roller elements 200 may be arranged at about a 90° offset from one another around bore 108, in accordance with some embodiments. As will be appreciated in light of this disclosure, other offset angles may be provided, as desired, in accordance with other embodiments. For instance, in some embodiments, roller elements 200 may be offset around bore 108 at about 15°, 30°, 45°, 60°, or 75°. In some other embodiments, roller elements 200 may be offset around bore 108 at about 105°, 120°, 135°, 150°, 165°, or 180°. In a more general sense, any two given roller elements 200 may be offset from one another around bore 108 at an angle in the range of about 15-180°, in accordance with some embodiments. In some specific cases, any two given roller elements 200 may be offset from one another around bore 108 at an angle in the range of about 45-180°.

As can be seen further from FIGS. 4-6, for example, roller elements 200 may be situated in a substantially linear arrangement within body portion 100. In such an arrangement, roller elements 200 may extend along a longitudinal axis of bore 108. As will be appreciated in light of this disclosure, non-linear arrangements may be provided instead, in accordance with other embodiments. Roller elements 200 may be configured to roll in a direction substantially parallel to (e.g., in-line with) a longitudinal axis of bore 108.

In some cases, roller element 200 may include one or more coating layers disposed thereon. A given optional coating layer generally may be configured, in accordance with some embodiments, to contact (e.g., directly or indirectly) the exterior of a given type of tubing and to facilitate the passing of that tubing through device 10 while minimizing (or otherwise reducing) the likelihood of bunching or jamming, whether friction related or otherwise. A given optional coating layer may include any of a wide range of materials. For instance, a given coating layer may include any one (or combination) of a rubber, a urethane, a ceramic, polytetrafluoroethylene (PTFE), an anti-bacterial material, an anti-microbial material, and an anti-viral material, to name a few options. In some cases, a given coating layer may be disposed on substantially all of a tubing contact surface of roller element 200. In some cases, a given coating layer may be disposed on only a portion of a tubing contact surface of roller element 200 (e.g., over an entire length but not an entire circumference, over an entire circumference but not an entire length, in a limited region, etc.). In some cases, a tubing contact surface of roller element 200 may include at least two coating layers disposed laterally adjacent one another (e.g., neighboring one another). In some cases, a tubing contact surface of roller element 200 may include at least two coating layers disposed radially adjacent one another (e.g., vertically stacked). In some cases, a tubing contact surface of roller element 200 may include at least two coating layers disposed in an at least partially overlapping manner.

As previously noted, device 10 further may include a clamping mechanism 300. FIG. 8 illustrates a view of a clamping mechanism 300 configured in accordance with an embodiment of the present disclosure. As can be seen, clamping mechanism 300 may include a plurality of jaw elements 310 and a drive element 330, each discussed in turn below. Generally, clamping mechanism 300 may be configured, in accordance with some embodiments, to releasably clamp onto the exterior of tubing exiting bore 108 of device 10. The amount of clamping force applied by clamping mechanism 300 may be customized, as desired for a given target application or end-use.

As previously noted, clamping mechanism 10 may include a plurality of jaw elements 310. FIGS. 9-10 illustrate several views of a jaw element 310 configured in accordance with an embodiment of the present disclosure. Generally, a given jaw element 310 may be configured, in accordance with some embodiments, to temporarily contact the exterior of tubing exiting bore 108, applying a force thereto. Through the cooperation of the plurality of jaw elements 310, a net clamping force may be applied to the exterior of such tubing.

The geometry and dimensions of a given jaw element 310 may be customized, as desired for a given target application or end-use. As can be seen in FIGS. 9-10, for example, a given jaw element 310 may be of generally wedge-shaped prism geometry, in accordance with some embodiments. As will be appreciated in light of this disclosure, other geometries may be provided instead, in accordance with other embodiments. In some cases, all (or some sub-set) of jaw elements 310 may be of the same geometry, whereas in other cases, at least one jaw element 310 may differ in geometry from at least one other jaw element 310.

The quantity and arrangement of jaw elements 310 may be customized, as desired for a given target application or end-use. For instance, as can be seen from FIGS. 1 and 8, clamping mechanism 300 may include four jaw elements 310 arranged adjacent one another in a common plane such that inner vertices 324 thereof generally point toward one another, in accordance with some embodiments. As will be appreciated in light of this disclosure, lesser (e.g., two or three) or greater (e.g., five, six, or more) quantities may be utilized, in accordance with other embodiments. Moreover, non-planar arrangements of jaw elements 310 may be provided, in accordance with some embodiments. In accordance with some embodiments, inner vertices 324 of the four jaw elements 320 may substantially surround a longitudinal axis of bore 108.

The material composition of a given jaw element 310 may be customized, as desired for a given target application or end-use. In some embodiments, a given jaw element 310 may be comprised of a plastic material, such as, for example, acrylonitrile butadiene styrene (ABS), polypropylene, or other suitable plastic(s). In some embodiments, a given jaw element 310 may be comprised of a composite material. A given jaw element 310 may be of monolithic (e.g., single-piece) or polylithic (e.g., multi-piece) construction, as desired.

Also, as can be seen from FIGS. 9-10, a given jaw element 310 may include a recess 312 configured to receive and retain a pin 314. Recess 312 may traverse a full (or partial) thickness of jaw element 310, allowing pin 314 to extend beyond jaw element 310 to be received by a corresponding slot 334 of drive element 330 (discussed below). The geometry and dimensions of recess 312 and associated pin 314 may be customized, as desired for a given target application or end-use.

As can be seen further from FIGS. 9-10, an edge surface 316 of a given jaw element 310 may include one or more recesses 318 configured to receive and retain pin(s) 320. Recess(es) 318 may traverse a full (or partial) width/length of jaw element 310. Pin(s) 320 may be utilized in mounting of a given jaw element 310 (within collar portion 112) to a given mounting region 116 of body portion 100. The geometry and dimensions of recess(es) 318 and associated pin(s) 320 may be customized, as desired for a given target application or end-use.

Furthermore, as can be seen from FIG. 9, a given jaw element 310 may include an inner vertex 324 configured to contact (directly or indirectly) tubing exiting bore 108. Inner vertex 324 may be rounded to a given degree, the radius of curvature of which may be customized, as desired for a given target application or end-use. As will be appreciated in light of this disclosure, it may be desirable to provide inner vertex 324 with a curvature that is generally compatible with the curvature of the exterior of the tubing passing through device 10. In some cases, a given inner vertex 324 may be of substantially constant radius of curvature. In some cases, a given inner vertex 324 may have one or more regions of convexity and one or more regions of concavity. In such instances, a given region of convexity or concavity may have a curvature that is generally compatible with the curvature of the exterior of the tubing passing through device 10.

As previously noted, clamping mechanism 300 also may include a drive element 330 (see FIG. 8). Generally, drive element 330 may be configured, in accordance with some embodiments, to transform rotary motion thereof into linear motion (e.g., radially inward/outward motion) of jaw elements 310 within collar portion 112. In some instances, drive element 330 may be configured to serve, at least in part, as a bushing or collar disposed against second end face 104 of body portion 100. In a general sense, drive element 330 may be configured to drive jaw elements 310 radially inward toward one another in applying a clamping force to the tubing exterior.

The geometry and dimensions of drive element 330 may be customized, as desired for a given target application or end-use. As can be seen from FIG. 8, for example, drive element 330 may be of substantially annular (e.g., ring-shaped) geometry, in accordance with some embodiments. Some example such geometries may include circular, elliptical, square, rectangular, pentagonal, hexagonal, heptagonal, octagonal, etc., ring-shaped geometries. As will be appreciated in light of this disclosure, other geometries may be provided, in accordance with other embodiments.

Moreover, the material composition of drive element 330 may be customized, as desired for a given target application or end-use. In some embodiments, drive element 330 may be comprised of any one or more of the example materials discussed above with respect to jaw element(s) 310. Drive element 330 may be of monolithic (e.g., single-piece) or polylithic (e.g., multi-piece) construction, as desired.

As can be seen from FIG. 8, drive element 330 may have a tab portion 332 extending therefrom. Tab portion 332 may be configured, in accordance with some embodiments, to extend through groove 114 of body portion 100 when drive element 330 is disposed within collar portion 112 of body portion 100. The geometry and dimensions of tab portion 332 may be customized, as desired for a given target application or end-use. Tab portion 332 may be configured, in accordance with some embodiments, to have a force applied thereto (or otherwise be manipulated) to effectuate rotation (or other movement) of drive element 330.

As can be seen further from FIG. 8, drive element 330 may have formed therein one or more slots 334. A given slot 334 may be configured, in accordance with some embodiments, to host a biasing element 336 (e.g., a spring) and to receive and guide a pin 314 (associated with a given jaw element 310). In this manner, biasing element 336 may be utilized to facilitate return of a given jaw element 310 from a deflected position (e.g., a closed position) to a non-deflected position (e.g., an open position). To that end, biasing element 336 may be incident with the side of a given pin 314 within a slot 334.

The quantity of biasing elements 336 and the biasing force (e.g., spring force) thereof also may be customized, as desired for a given target application or end-use. As can be seen from FIG. 8, for example, two biasing elements 336 may be provided in corresponding slots 334 of drive element 330, in accordance with some embodiments. As will be appreciated in light of this disclosure, lesser (e.g., one) or greater quantities (e.g., three, four, or more) of biasing elements 336 may be provided, in accordance with other embodiments.

The geometry and dimensions of a given slot 334 may be customized, as desired for a given target application or end-use. As can be seen from FIG. 8, for example, a given slot 334 may be substantially oval-shaped, in accordance with some embodiments. As will be appreciated in light of this disclosure, other geometries (e.g., elliptical, rectangular, etc.) may be provided instead, in accordance with other embodiments. Also, a given slot 334 may have a grade/slope that provides drive element 330 with a camming action that effectuates linear movement of jaw element(s) 310 radially inward/outward as drive element 330 rotates. To that end, the profile of a given slot 310 may be customized, as desired for a given target application or end-use.

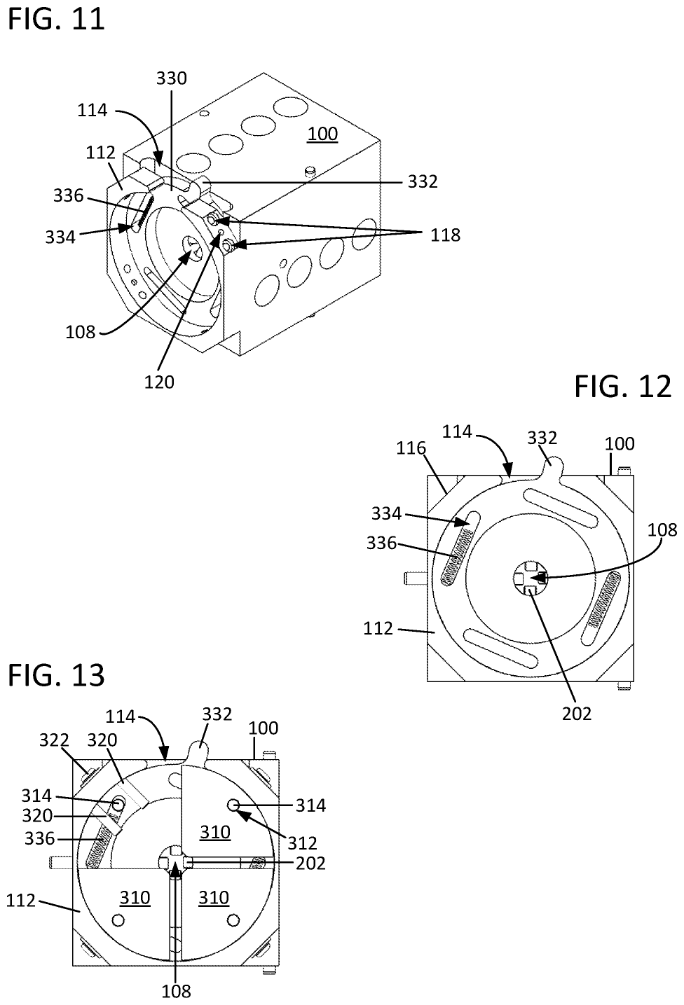

FIGS. 11-13 illustrate several views of the installation of a clamping mechanism 300 within collar portion 112, in accordance with an embodiment of the present disclosure. In general, clamping mechanism 300 may be mounted to body portion 100 (e.g., within collar portion 112), in accordance with some embodiments. As can be seen, drive element 330 may be disposed within (e.g., slidably inserted into) collar portion 112, through groove 114. Tab portion 332 may extend through groove 114. Biasing element(s) 336 may be disposed within slot(s) 334. Each jaw element 310 may be disposed within collar portion 112 such that its associated pin 314 extends into a corresponding slot 334 of drive element 330 (and resides proximate a biasing element 336, if present in said slot 334). Each jaw element 310 also may be mounted to a corresponding mounting region 116, having pins 320 inserted into openings 318 and 118 and fastening element 322 inserted into opening 120. In accordance with some embodiments, clamping mechanism 300 may be disposed at an end (e.g., at second end face 104) of body portion 100. In some cases, clamping mechanism 200 may be disposed outside of body portion 100, within collar portion 112.

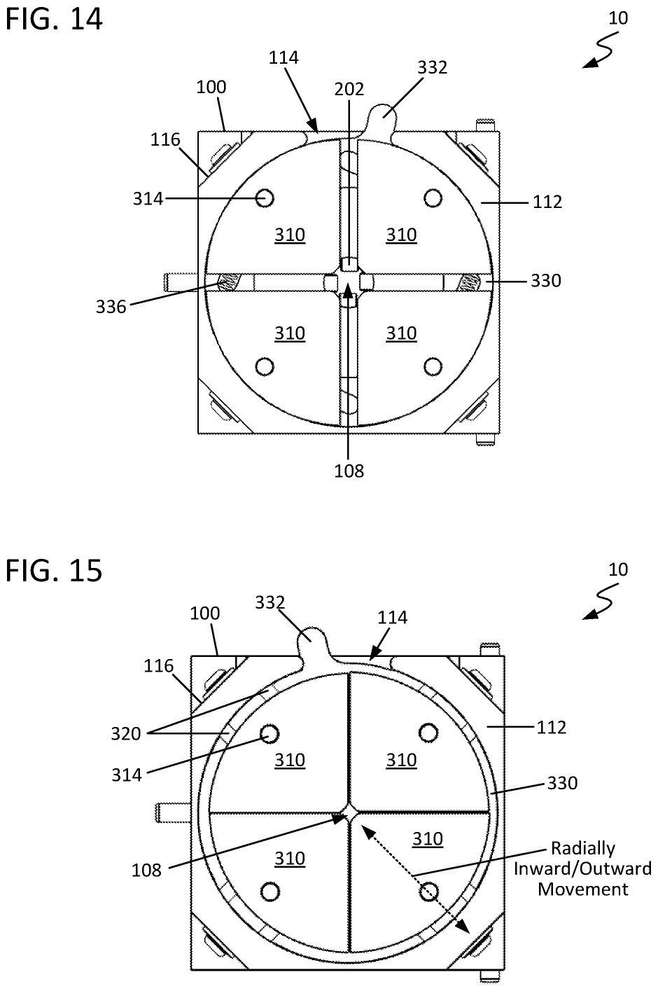

FIG. 14 illustrates a view of clamping mechanism 300 in a first state (e.g., an open or undeflected state) in accordance with an embodiment of the present disclosure. FIG. 15 illustrates a view of clamping mechanism 300 in a second state (e.g., a closed or deflected state) in accordance with an embodiment of the present disclosure. In operation of device 10, as drive element 330 rotates in one direction, each jaw element 310 may advance radially inward. As drive element 330 rotates in the opposite direction, each jaw element 310 may retreat radially outward.

With drive element 330 disposed within collar portion 112 of body portion 100, tab portion 332 may extend through groove 114. In this manner, tab portion 332 may advance/retract within groove 114 to effectuate rotation of drive element 330 within collar portion 112. To that end, tab portion 332 may be configured to be operated manually and/or mechanically, as desired.

As jaw elements 310 are moved radially inward, they may come to contact (directly or indirectly) the exterior of tubing exiting bore 108 of body portion 100. In this manner, jaw elements 310 may provide a net clamping force which holds the tubing in place, for instance, for measurement, alignment, and/or cutting.

### FURTHER EXAMPLES

The following examples pertain to some further configurations of the disclosed flexible tubing guidance device, from which numerous permutations and combinations will be apparent.

Example 1 is a flexible tubing guidance device. The device includes a body portion having a bore formed therein. The device further includes a plurality of roller elements disposed within the body portion and at least partially extending into the bore to contact flexible tubing passing through the bore.

Example 2 includes the subject matter of any of Examples 1 and 3-33, wherein the plurality of roller elements is configured to roll in a direction substantially in-line with a longitudinal axis of the bore.

Example 3 includes the subject matter of any of Examples 1-2 and 4-33, wherein the plurality of roller elements is provided in a substantially linear arrangement that extends along a longitudinal axis of the bore.

Example 4 includes the subject matter of any of Examples 1-3 and 5-33, wherein at least one of the plurality of roller elements is configured to contact the flexible tubing directly.

Example 5 includes the subject matter of any of Examples 1˜4 and 6-33, wherein at least one of the plurality of roller elements is configured to contact the flexible tubing indirectly through at least one intervening layer.

Example 6 includes the subject matter of any of Examples 1-5 and 7-33, wherein the plurality of roller elements comprises at least one ball bearing on an axle.

Example 7 includes the subject matter of any of Examples 1-6 and 8-33, wherein at least one of the plurality of roller elements has a coating layer disposed thereon such that the coating layer contacts the flexible tubing directly.

Example 8 includes the subject matter of any of Examples 1-7 and 9-33, wherein the plurality of roller elements comprises at least two roller elements offset from one another around the bore at an angle in the range of about 45°-180°.

Example 9 includes the subject matter of Example 8, wherein the angle is about 45°.

Example 10 includes the subject matter of Example 8, wherein the angle is about 90°.

Example 11 includes the subject matter of Example 8, wherein the angle is about 120°.

Example 12 includes the subject matter of Example 8, wherein the angle is about 180°.

Example 13 includes the subject matter of any of Examples 1-12 and 14-33, wherein the bore extends from a first end face of the body portion to a second end face of the body portion.

Example 14 includes the subject matter of any of Examples 1-13 and 15-33, wherein the bore is substantially linear.

Example 15 includes the subject matter of any of Examples 1-14 and 16-33, wherein at least a portion of the bore is of closed-curve cross-sectional geometry.

Example 16 includes the subject matter of Example 15, wherein the closed-curve cross-sectional geometry is substantially circular.

Example 17 includes the subject matter of any of Examples 1-16 and 18-33, the device further comprising a clamping mechanism configured to apply a clamping force to an exterior of the flexible tubing exiting the bore.

Example 18 includes the subject matter of any of Examples 1-17 and 19-33, wherein the clamping mechanism is disposed at an end of the body portion.

Example 19 includes the subject matter of any of Examples 1-18 and 20-33, wherein the clamping mechanism is disposed outside of the body portion.

Example 20 includes the subject matter of any of Examples 1-19 and 21-33, wherein the clamping mechanism comprises: a plurality of jaw elements; and a drive element configured to drive the plurality of jaw elements radially inward toward one another in applying the clamping force to the exterior of the flexible tubing.

Example 21 includes the subject matter of any of Examples 1-20 and 22-33, wherein the plurality of jaw elements comprises at least one jaw element that is of substantially wedge-shaped prism geometry.

Example 22 includes the subject matter of any of Examples 1-21 and 23-33, wherein the plurality of jaw elements comprises four jaw elements of substantially wedge-shaped prism geometry and arranged adjacent one another in a common plane such that inner vertices of the four jaw elements generally point toward one another.

Example 23 includes the subject matter of any of Examples 1-22 and 24-33, wherein the inner vertices substantially surround a longitudinal axis of the bore.

Example 24 includes the subject matter of any of Examples 1-23 and 25-33, wherein the plurality of jaw elements comprises at least one jaw element having a rounded inner vertex configured to contact the exterior of the flexible tubing.

Example 25 includes the subject matter of any of Examples 1-24 and 26-33, wherein the drive element is of substantially annular geometry.

Example 26 includes the subject matter of any of Examples 1-25 and 27-33, wherein the drive element includes a tab portion configured to have a force applied thereto to effectuate rotation of the drive element.

Example 27 includes the subject matter of any of Examples 1-26 and 28-33, wherein in being configured to drive the plurality of jaw elements radially inward toward one another, the drive element is configured with a camming action.

Example 28 includes the subject matter of any of Examples 1-27 and 29-33, wherein: the drive element has at least one slot formed therein; and at least one biasing element is disposed within the at least one slot.

Example 29 includes the subject matter of Example 28, wherein the at least one biasing element comprises a spring.

Example 30 includes the subject matter of any of Examples 1-29 and 31-33, wherein the body portion includes a collar portion extending from an end face thereof.

Example 31 includes the subject matter of Example 30, wherein the clamping mechanism is mounted within the collar portion.

Example 32 includes the subject matter of any of Examples 1-31 and 33, wherein the body portion includes a groove formed adjacent the collar portion.

Example 33 includes the subject matter of Example 32, wherein the drive element is disposed within the groove.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description. Future-filed applications claiming priority to this application may claim the disclosed subject matter in a different manner and generally may include any set of one or more limitations as variously disclosed or otherwise demonstrated herein.
jamming of the flexible tubing during processing thereof.

What is claimed is:

1. A flexible tubing guidance device comprising:
a body portion having a bore formed therein; and
a plurality of roller elements disposed within the body portion and at least partially extending into the bore to contact flexible tubing passing through the bore.

2. The device of claim 1, wherein the plurality of roller elements is configured to roll in a direction substantially in-line with a longitudinal axis of the bore.

3. The device of claim 1, wherein the plurality of roller elements is provided in a substantially linear arrangement that extends along a longitudinal axis of the bore.

4. The device of claim 1, wherein at least one of the plurality of roller elements is configured to contact the flexible tubing directly.

5. The device of claim 1, wherein at least one of the plurality of roller elements is configured to contact the flexible tubing indirectly through at least one intervening layer.

6. The device of claim 1, wherein the plurality of roller elements comprises at least one ball bearing on an axle.

7. The device of claim 1, wherein at least one of the plurality of roller elements has a coating layer disposed thereon such that the coating layer contacts the flexible tubing directly.

8. The device of claim 1, wherein the plurality of roller elements comprises at least two roller elements offset from one another around the bore at an angle in the range of about 45°-180°.

9. The device of claim 8, wherein the angle is about 45°.

10. The device of claim 8, wherein the angle is about 90°.

11. The device of claim 8, wherein the angle is about 120°.

12. The device of claim 8, wherein the angle is about 180°.

13. The device of claim 1, wherein the bore extends from a first end face of the body portion to a second end face of the body portion.

14. The device of claim 1, wherein the bore is substantially linear.

15. The device of claim 1, wherein at least a portion of the bore is of closed-curve cross-sectional geometry.

16. The device of claim 15, wherein the closed-curve cross-sectional geometry is substantially circular.

17. The device of any of claims 1-16, further comprising a clamping mechanism configured to apply a clamping force to an exterior of the flexible tubing exiting the bore.

18. The device of claim 17, wherein the clamping mechanism is disposed at an end of the body portion.

19. The device of claim 17, wherein the clamping mechanism is disposed outside of the body portion.

20. The device of claim 17, wherein the clamping mechanism comprises:
a plurality of jaw elements; and
a drive element configured to drive the plurality of jaw elements radially inward toward one another in applying the clamping force to the exterior of the flexible tubing.

21. The device of claim 20, wherein the plurality of jaw elements comprises at least one jaw element that is of substantially wedge-shaped prism geometry.

22. The device of claim 20, wherein the plurality of jaw elements comprises four jaw elements of substantially wedge-shaped prism geometry and arranged adjacent one another in a common plane such that inner vertices of the four jaw elements generally point toward one another.

23. The device of claim 22, wherein the inner vertices substantially surround a longitudinal axis of the bore.

24. The device of claim 20, wherein the plurality of jaw elements comprises at least one jaw element having a rounded inner vertex configured to contact the exterior of the flexible tubing.

25. The device of claim 20, wherein the drive element is of substantially annular geometry.

26. The device of claim 20, wherein the drive element includes a tab portion configured to have a force applied thereto to effectuate rotation of the drive element.

27. The device of claim 20, wherein in being configured to drive the plurality of jaw elements radially inward toward one another, the drive element is configured with a camming action.

28. The device of claim 20, wherein:
the drive element has at least one slot formed therein; and
at least one biasing element is disposed within the at least one slot.

29. The device of claim 28, wherein the at least one biasing element comprises a spring.

30. The device of claim 20, wherein the body portion includes a collar portion extending from an end face thereof.

31. The device of claim 30, wherein the clamping mechanism is mounted within the collar portion.

32. The device of claim 30, wherein the body portion includes a groove formed adjacent the collar portion.

33. The device of claim 32, wherein the drive element is disposed within the groove.
